(19) United States
(12) Patent Application Publication
(10) Pub. No.: US 2002/0042954 A1
(43) Pub. Date: Apr. 18, 2002

(54) Infant wedge positioner

(76) Inventor: Mariann C. Straub, Winnetka, IL (US)

Correspondence Address: OLSON & HIERL, LTD., 36th Floor, 20 North Wacker Drive, Chicago, IL, 60606, US

(21) Appl. No.: 09/942,267

(22) Filed: Aug. 27, 2001

Related U.S. Application Data
(63) Continuation-in-part of application No. 29/127,113, filed on Jul. 31, 2000.

(51) Int. Cl. B68G 5/00; A47C 16/00; A47C 20/02

(52) U.S. Cl. 5/655

(57) ABSTRACT

An infant wedge positioner positions an infant in a supine position for sleeping and reduces the risk of developing positional plagiocephaly. The infant positioner includes a first support bolster for supporting the torso and head of an infant. A second support bolster is connected to the first support bolster in spaced relationship for holding the infant snugly. The first support bolster has an upper surface that slopes transversely such that the infant's head is caused to rotate to the side while sleeping in the supine position.

### FIELD OF THE INVENTION

This application relates generally to devices for positioning an infant while sleeping, and relates more particularly to an infant positioner for reducing the risk of sudden infant death while also reducing the risk of positional plagiocephaly, i.e., a flattened or misshapen region of the skull.

### BACKGROUND OF THE INVENTION

Medical studies have shown that infants who sleep on their backs or sides have a reduced risk of dying suddenly from Sudden Infant Death Syndrome (SIDS), compared to infants who sleep on their stomachs. Efforts by the American Academy of Pediatrics to disseminate this information to pediatricians and parents has resulted in an increase in the practice of placing infants in a supine position, i.e., on their backs for sleeping. A decrease in the incidence of SIDS has been observed in recent years.

An unanticipated effect of the increasingly widespread practice of placing infants in a supine position for sleeping has been an increase in the number of infants developing positional plagiocephaly, i.e., a flat or misshapen area on the back of the skull. A newborn infant's skull is relatively deformable due to flexibility of the bone plates and non-fusion of the sutures between adjacent bone plates. This property of deformability permits the child's head to pass between the bones of the mother's pelvis during birth. As the infant matures, however, the bone plates of the skull become increasingly rigid and the sutures eventually fuse.

When an infant spends many hours daily sleeping exclusively on his back, the bones at the back of the skull tend to flatten from pressure against the sleeping surface due to the weight of the child's head. If the practice of sleeping exclusively on the back is continued through the critical period during which the bones of the skull become rigid, the flat or misshapen area on the back of the skull can become permanent.

It would be desirable to provide a structure that maintains the position of an infant on its back during sleep to gain the benefit of reducing the risk of dying from SIDS, but that also reduces the risk of the infant developing positional plagiocephaly. This and other desirable benefits are provided by the present invention described below in terms of a preferred embodiment.

### SUMMARY OF THE INVENTION

An infant positioner is provided for positioning an infant in a supine position for sleeping. The infant positioner also reduces the risk of developing positional plagiocephaly in an infant sleeping in a supine position. The infant positioner includes a first support bolster and a second support bolster connected thereto in spaced relationship. The spacing accommodates an infant's torso lying in a supine position on the first support bolster. The first support bolster has at least one upper surface that slopes transversely such that the infant's head is caused to rotate to the side while sleeping in the supine position.

Other advantages of the present invention will be apparent from the description of preferred embodiment, made with reference to the drawings, that follows.

### BRIEF DESCRIPTION OF THE DRAWINGS

In the drawings,

FIG. 1 is a perspective view of an infant wedge positioner configured in accordance with the present invention, showing an infant thereupon;

FIG. 2 is a side elevational view of the infant wedge positioner of FIG. 1;

FIG. 3 is an opposite side elevational view of the infant wedge positioner of FIG. 1;

FIG. 4 is a foot end view of the infant wedge positioner of FIG. 1;

FIG. 5 is a head end view of the infant wedge positioner and infant of FIG. 1;

FIG. 6 is a top plan view of the infant wedge positioner of FIG. 1; and

FIG. 7 is a bottom plan view of the infant wedge positioner of FIG. 1.

### DETAILED DESCRIPTION OF THE PREFERRED EMBODIMENT

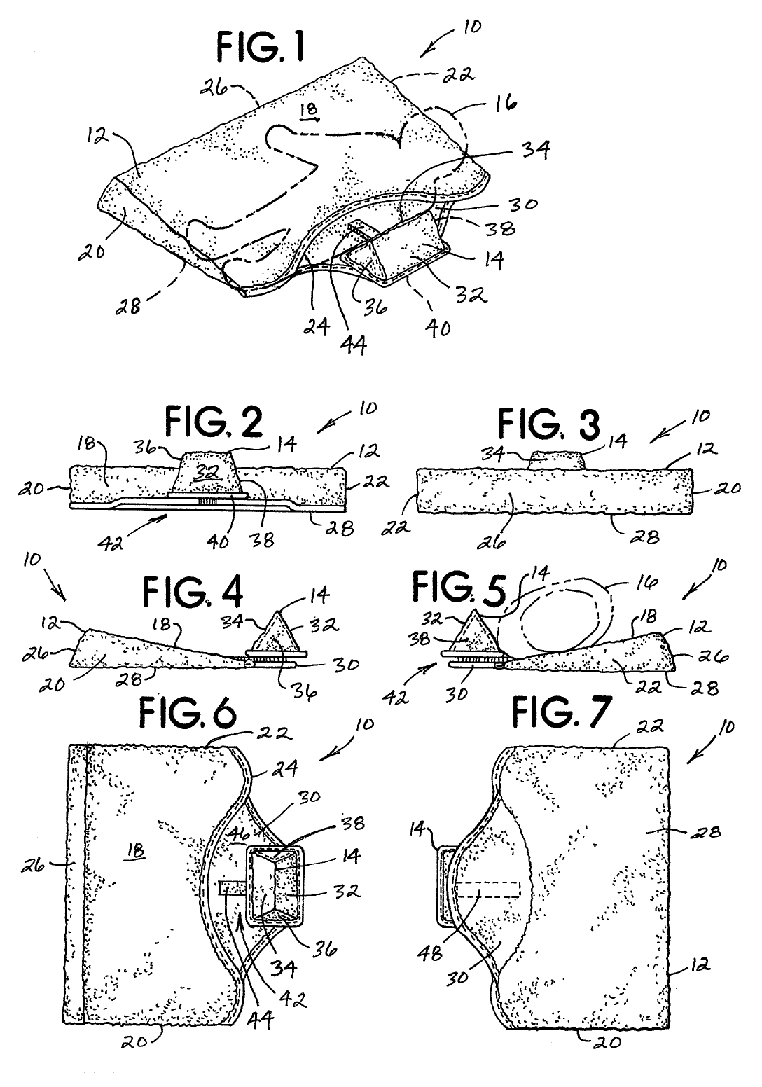

Referring to FIGS. 1-7, there is illustrated a preferred embodiment of an infant wedge positioner 10 constructed in accordance with the present invention. The infant wedge positioner 10 includes a first support bolster 12 and a second support bolster 14 that is movably connectable to first support bolster 12 in a range of positions to facilitate adjusting the fit of infant positioner 10 to an individual infant, as described further below.

First support bolster 12 is resilient, elastomeric, compressible and shape retaining. It is preferred to use a cross-sectional configuration for first support bolster 12 having at least a lower flat side to achieve a desired stable relationship with a mattress, floor, or other surface upon which infant wedge positioner is to be placed in use. It is further preferred that the first support bolster have at least one upper surface 18 that slopes transversely across substantially the whole width of the first support bolster 12.

First support bolster 12 has an exposed upper face 18, a triangular foot end 20, a triangular head end 22, a side edge 24, a side face 26, and a lower face 28. Upper and lower faces 18 and 28, side face 26, and triangular ends 20 and 22 are covered with cotton terry cloth or cotton flannel which, advantageously, is soft, liquid absorbent, sewable, conventionally washable, low in cost, and has a non-slip surface. All of these advantages make this material well suited for use with an infant. The core of first support bolster 12 is preferably polyurethane foam. Other materials are also contemplated such as, for example, polyester fiber fill. When a polyurethane foam is used, a conventional hot water and detergent washing procedure for infant wedge positioner 10 may not be desirable because of the heat sensitivity of foams in common use. Washing in cold or warm water would be more preferred.

Extending from side edge 24 is a mat extension 30 that is generally flat, coplanar with the lower surface 28 of first support bolster 12, and covered with the same cotton terry cloth or cotton flannel of which first support bolster 12 is covered. The fabric covering upper and lower faces 18 an 28, ends 20 and 22, and side face 26 is preferably sewn to the fabric of mat extension 30 to retain first support bolster 12 in a fixed location and orientation with respect to mat extension 30. More specifically, first support bolster 12 is disposed with side edge 24, comprising one longitudinal apex of the wedge-shaped bolster 12, connected to and forming one edge of mat extension 30. Preferably, side edge 24, at the intersection of first support bolster 12 and mat extension 30, is generally curved concavely as viewed from a point offset away from side edge 24.

Second support bolster 14 is somewhat pyramidally shaped, and like first support bolster 12 is resilient, elastomeric, compressible and shape-retaining. In transverse cross-section, second support bolster 14 preferably has the configuration of an equilateral triangle. Other cross-sectional configurations can be used if desired. Second support bolster 14 has a lower surface adjacent mat extension 30 for stability, similar to first support bolster 12, but is not permanently attached in a fixed position to mat extension 30, as described further below.

Second support bolster 14 has two exposed, longitudinal upper faces 32 and 34, a triangular foot end 36 and a triangular shoulder end 38. The lower longitudinal face 40 of support bolster 14 lies adjacent mat extension 30. As with first support bolster 12, upper faces 32 and 34, triangular ends 36 and 38, and lower face 40 are covered with the same or similar fabric material, preferably terry cloth or cotton flannel, of which first support bolster 12 is covered. Like first support bolster 12, the core of second support bolster 14 is preferably polyurethane foam, but other materials are also contemplated such as, for example, polyester fiber fill.

The fabric covering upper faces 32 and 34 and ends 36 and 38 of second support bolster 14 is preferably sewn to fabric of like kind that covers the lower longitudinal face 40 of support bolster 14. In other words, the core material of second support bolster 14 is covered on all five faces with fabric, preferably terry cloth or cotton flannel.

Second support bolster 14 is not attached in a fixed location and orientation with respect to mat extension 30, but rather is removably connected thereto, and hence to first support bolster 12, in a range of positions. Generally speaking, second support bolster 14 is disposed with the longitudinal apex generally parallel to and adjacent side edge 24, and offset laterally therefrom. To permit the location of second support bolster 14 to be adjusted relative to mat extension 30, a well-known hook and loop fabric fastener system 42 is employed. Fastener system 42 includes a first elongated strip component 44 having a plurality of fiber loops on the face thereof. Preferably, loop component 44 is attached to the top surface 46 of mat extension 30, with the loops facing upwardly. This arrangement is preferred because the loop component of the hook and loop fastener system is less scratchy than the hook portion, and the infant is more likely to come in contact with the portion attached to mat extension 30. Elongated loop component 44 is oriented transversely relative to the intended orientation of second support bolster 14 and therefore lies generally parallel to and about halfway between the planes defined by ends 20 and 22, while extending outwardly away from edge 24. Loop component 44 is stitched to mat extension 30.

Fastener system 42 further includes a second elongated strip component 48 having a plurality of hooks suitable for releasably engaging the loops of component 44 in well-known fashion. Hook component 48 is attached to the lower longitudinal face 40 of second support bolster 14 with the loops facing downwardly toward mat extension 30 and toward loop component 44. Elongated hook component 48 is oriented transversely relative to second support bolster 14 and is affixed to lower face 40 by stitching about halfway between triangular ends 36 and 38, so as to overlie loop component 44 in normal use. Hook component 48 has a length equal to or less than the width of the lower face 40 of second support bolster 14 to which it is affixed. Loop component 44 has a length greater than that of hook component 48, thereby permitting second support bolster 14 to be removably attached to mat extension 30 in a range of lateral positions relative to first support bolster 12.

In use, an infant 16 is placed on its back upon infant wedge positioner 10 for sleeping. The infant's body and head are disposed upon first support bolster 12. Second support bolster 14 is moved closer to or farther away from first support bolster 12, as required to engage and hold the infant snugly. The sloping upper face 18 of wedge-shaped first support bolster 12 causes the sleeping infant's head to rotate sideways under the force of gravity such that the infant's head is facing toward the base of the slope. This rotation, or turning, of the infant's head prevents the infant from developing a flat spot on the back of the skull, since the weight of the head is borne on the side of the head rather than on the back of the head.

While the present invention has been described in detail in terms of a preferred embodiment, the description is illustrative only and no limitation of the scope of the invention is intended thereby. The scope of the invention in which applicant is claiming exclusive rights is defined by the claims below.

I claim:

1. An infant wedge positioner for positioning an infant in a supine position for sleeping, and for reducing the risk of developing positional plagiocephaly while sleeping in a supine position, comprising:
a first support bolster; and
a second support bolster connected to the first support bolster in spaced relationship to accommodate an infant's body and head lying in a supine position on the first support bolster and adjacent the second support bolster, the first support bolster having at least one upper surface that slopes transversely such that the infant's head is caused to rotate to the side while sleeping in the supine position.

2. The infant wedge positioner of claim 1, wherein each of the first and second support bolsters has a substantially flat lower face for stability.

3. The infant wedge positioner of claim 1, wherein at least one of the first and second support bolsters has a transverse cross-sectional configuration that is triangular.

4. The infant wedge positioner of claim 1, wherein the second support bolster has first and second upper surfaces that adjoin at a longitudinal apex located at about the middle of the width of the second support bolster.

5. The infant wedge positioner of claim 1, wherein the first support bolster is covered with a soft, absorbent fabric on at least those faces exposed to the infant.

6. The infant wedge positioner of claim 1, wherein the first and second support bolsters are covered with a soft, absorbent fabric on at least those faces exposed to the infant.

7. The infant wedge positioner of claim 1, wherein the second support bolster is removably connectable to the first support bolster in a range of positions each differently spaced from the first support bolster to accommodate infants having torsos of different widths.

8. The infant positioner of claim 7, wherein the second support bolster is removably connectable by a hook and loop fabric fastener system having a loop component affixed to one of the first and second support bolsters, and a hook component affixed to the other of the first and second support bolsters.

9. The infant positioner of claim 1, wherein the first support bolster has a transverse width and the upper surface of the first support bolster traverses substantially the whole width of the first support bolster such that the infant's head is caused to turn in a desired direction.

10. The infant wedge positioner of claim 1, wherein the first support bolster includes a mat extension to which the second support bolster is attachable.

11. An infant positioner for positioning an infant in a supine position for sleeping, and for reducing the risk of developing positional plagiocephaly while sleeping in a supine position, comprising:
a first support bolster having an upper surface that slopes transversely, and being substantially wedge-shaped in transverse cross-section; and
a second support bolster connected to the first support bolster in spaced relationship to accommodate an infant's body and head lying in a supine position on the first support bolster and adjacent the second support bolster;
whereby the infant's head is caused to rotate to the side while sleeping in the supine position.

12. The infant wedge positioner of claim 11, wherein each of the first and second support bolsters has a substantially flat lower face for stability.

13. The infant wedge positioner of claim 11, wherein at least one of the first and second support bolsters has a transverse cross-sectional configuration that is triangular.

14. The infant wedge positioner of claim 11, wherein the second support bolster has first and second upper surfaces that adjoin at a longitudinal apex located at about the middle of the width of the second support bolster.

15. The infant wedge positioner of claim 11, wherein the first support bolster is covered with a soft, absorbent fabric on at least those faces exposed to the infant.

16. The infant wedge positioner of claim 11, wherein the first and second support bolsters are covered with a soft, absorbent fabric on at least those faces exposed to the infant.

17. The infant wedge positioner of claim 11, wherein the second support bolster is removably connectable to the first support bolster in a range of positions each differently spaced from the first support bolster to accommodate infants having torsos of different widths.

18. The infant positioner of claim 17, wherein the second support bolster is removably connectable by a hook and loop fabric fastener system having a loop component affixed to one of the first and second support bolsters, and a hook component affixed to the other of the first and second support bolsters.

19. The infant positioner of claim 11, wherein the first support bolster has a transverse width and the upper surface of the first support bolster traverses substantially the whole width of the first support bolster.

20. The infant wedge positioner of claim 11, wherein the first support bolster includes a mat extension to which the second support bolster is attachable.
